(19) United States
(12) Patent Application Publication
(10) Pub. No.: US 2025/0046927 A1
(43) Pub. Date: Feb. 6, 2025

(54) STRUCTURAL INTEGRATED BATTERY PACK

(71) Applicant: MAGNA INTERNATIONAL INC., Aurora (CA)

(72) Inventors: Christoph HÖFER, Hargelsberg (AT); Mehmed BECIRBASIC, Behamberg (AT); Johannes MARKTL, St. Valentin (AT)

(21) Appl. No.: 18/719,414

(22) PCT Filed: Dec. 14, 2022
(86) PCT No.: PCT/CA2022/051818

§ 371 Date: Jun. 13, 2024

Related U.S. Application Data
(60) Provisional application No. 63/289,776, filed on Dec. 15, 2021.

(51) Int. Cl. H01M 50/209; H01M 50/258

(52) U.S. Cl. CPC H01M 50/209; H01M 50/258; H01M 2220/20

(57) ABSTRACT

A battery pack for a vehicle includes a plurality of battery modules arranged in a first predetermined pattern, with each battery module of the plurality of battery modules including a plurality of battery cells arranged in a second predetermined pattern. Each battery module also includes an enclosure surrounding the plurality of cells and configured to function as a structural component of at least one of the battery pack or the vehicle.

### CROSS-REFERENCE TO RELATED APPLICATION

This PCT International Patent Application claims the benefit of U.S. Provisional Patent Application Ser. No. 63/289,776 filed on Dec. 15, 2021 titled “Structural Integrated Battery Pack,” the entire disclosure of which is hereby incorporated by reference

### FIELD

The present disclosure relates generally to battery packs incorporating many battery cells. More specifically, the present disclosure relates to battery packs for electrified vehicles (EVs).

### BACKGROUND

Electrified vehicles (EVs), such as fully electric vehicles, hybrid-electric vehicles, plug-in-hybrids, etc., include electric energy storage systems (ESS) for storing electric power. Conventional ESS devices, such as battery packs, are designed as an add-on to an existing structure of an EV. Conventional ESS devices may include many different separate parts each performing different functions, such as structural elements, electrical conductors, thermal conductors, etc. Vehicle weight is a driver of consumption and therefore electric range, which results in corresponding resource usage. By reducing weight of a vehicle, resources used in the vehicle and resources used for providing power to operate vehicle can also be reduced.

### SUMMARY

The present disclosure provides a battery pack for a vehicle. The battery pack comprises a plurality of battery modules arranged in a first predetermined pattern, with each battery module of the plurality of battery modules including a plurality of battery cells arranged in a second predetermined pattern. Each battery module also includes an enclosure surrounding the plurality of cells and configured to function as a structural component of at least one of the battery pack or the vehicle.

The present disclosure also provides a battery module for a battery pack in a vehicle, the battery module comprises: a plurality of battery cells arranged in a predetermined pattern; and an enclosure surrounding the plurality of cells and configured to provide a structural component of the battery pack or the vehicle.

### BRIEF DESCRIPTION OF THE DRAWINGS

Further details, features and advantages of designs of the invention result from the following description of embodiment examples in reference to the associated drawings.

FIG. 1 shows a perspective view of a battery pack in accordance with an aspect of the present disclosure;

FIG. 2A shows a top view of the battery pack of FIG. 1;

FIG. 2B shows an enlarged section of FIG. 2A;

FIG. 3 shows the battery pack of FIG. 1 in a state of assembly with only one battery module;

FIG. 4 shows a top cover of the of the battery pack of FIG. 1;

FIG. 5A shows a perspective view of a battery module, in accordance with an aspect of the present disclosure;

FIG. 5B shows a top view of the battery module of FIG. 5A;

FIG. 5C shows a side view of the battery module of FIG. 5A;

FIG. 6A shows an arrangement of battery cells in the battery module of FIG. 5A;

FIG. 6B shows a top view of the arrangement of battery cells of FIG. 6A; and

FIG. 6C shows a side view of the arrangement of battery cells of FIG. 6A.

### DETAILED DESCRIPTION

Referring to the drawings, the present invention will be described in detail in view of following embodiments, which provide a battery pack design that reduces weight by combining the functionality of one or more of the different separate parts. Such a battery pack design may provide for reduction in weight and cost when incorporated in a vehicle.

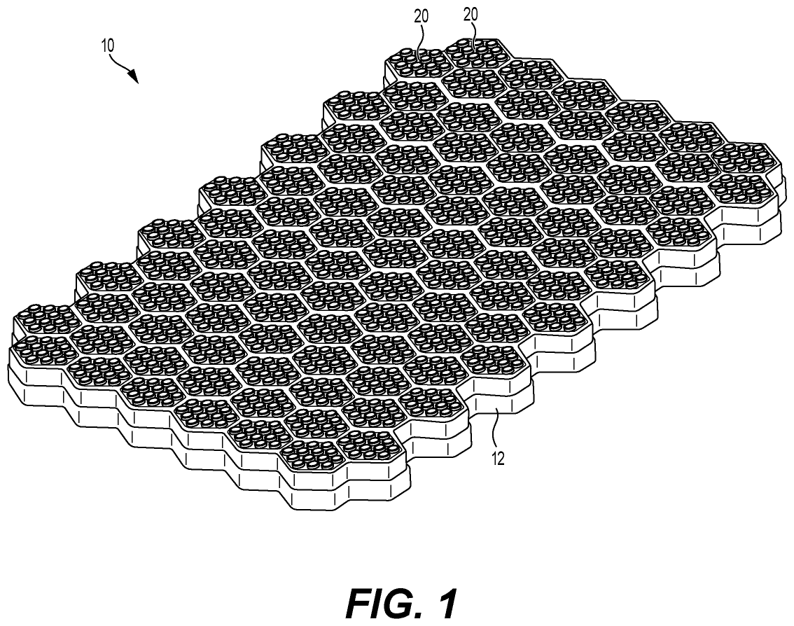

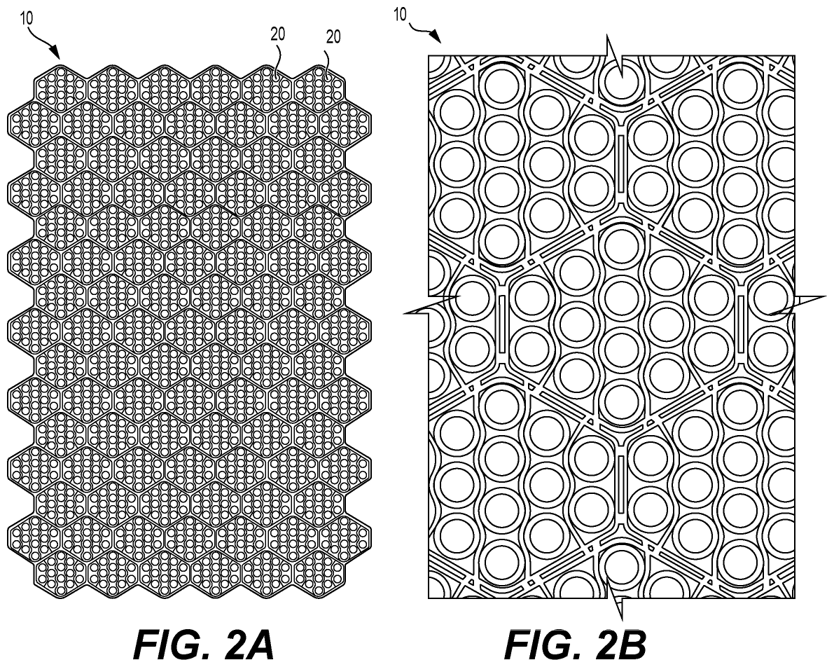

As shown in FIG. 1 and FIGS. 2A-2B, a battery pack 10 includes a baseplate 12 and a plurality of battery modules 20 arranged in a first predetermined pattern. Each of the battery modules 20 is shaped as a hexagonal prism, and the first predetermined pattern is a honeycomb pattern, with alternating rows of the battery modules 20 being offset by half a width thereof to interlock. The battery pack 10 shown in FIG. 1 includes 15 rows, each including 6 or 7 of the battery modules 20, with the rows alternating between including 6 or 7 of the battery modules 20. In total, the battery pack 10 includes 97 of the battery modules 20. Each of the battery modules 20 includes fourteen (14) battery cells 22, bringing the total number of battery cells 22 in the battery pack 10 to thirteen-hundred, fifty-eight (1358). Alternatively, the battery pack 10 may have a different configuration, such as twelve (12) rows of six (6) or seven (7) each of the battery modules 20, each having fourteen (14) battery cells 22. Such a configuration with 12 rows would include a total of eleven hundred, seventy-six (1176) of the battery cells 22.

In some embodiments, the baseplate 12 has a generally flat shape defining the first predetermined pattern and configured to hold the plurality of battery modules 20 thereupon. In some embodiments, and as shown in FIG. 1, the first predetermined pattern includes a single layer of the battery modules 20 disposed on the baseplate 12. However, the first predetermined pattern may include two or more layers of the battery modules 20 stacked on top of one another.

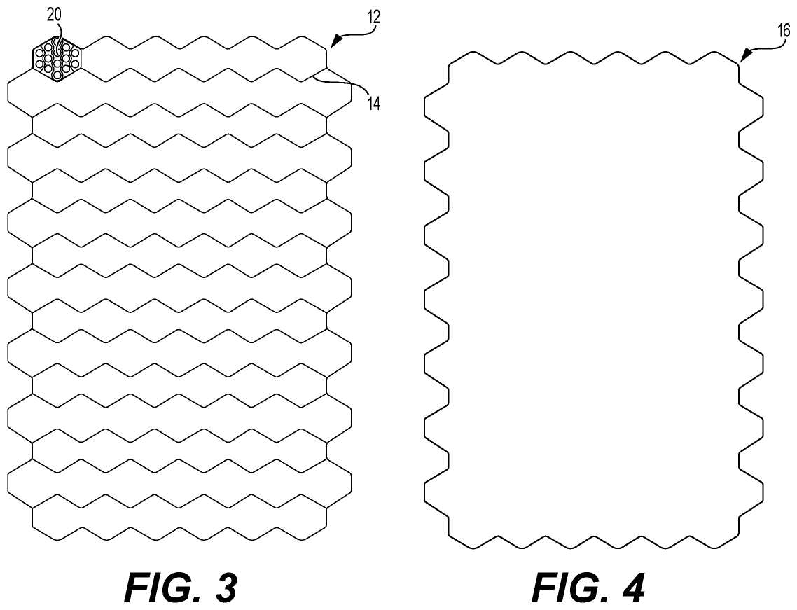

FIG. 3 shows the battery pack of FIG. 1 in a state of assembly with only one battery module 20 on the baseplate 12. FIG. 3 shows the baseplate 12 having a generally flat shape with an upper surface defining the first predetermined pattern for holding the plurality of battery modules 20 thereupon. Specifically, the upper surface of the baseplate 12 defines a plurality of ridges 14 configured to engage the battery modules 20 to locate the battery modules 20 in the first predetermined pattern. In some embodiments, the ridges 14 may prevent the battery modules 20 from sliding relative to the upper surface of the baseplate 12.

FIG. 4 shows a top cover 16 of the battery pack 10. The top cover 16 has a generally flat shape defining the first predetermined pattern and is configured overly the plurality of battery modules 20. Thus, the top cover 16 may be disposed parallel to and spaced apart from the baseplate 12, with the battery modules 20 disposed therebetween. The top cover 16 may be secured to the baseplate 12 with one or more fasteners, such as bolts or straps (not shown) to hold the battery modules 20 therebetween.

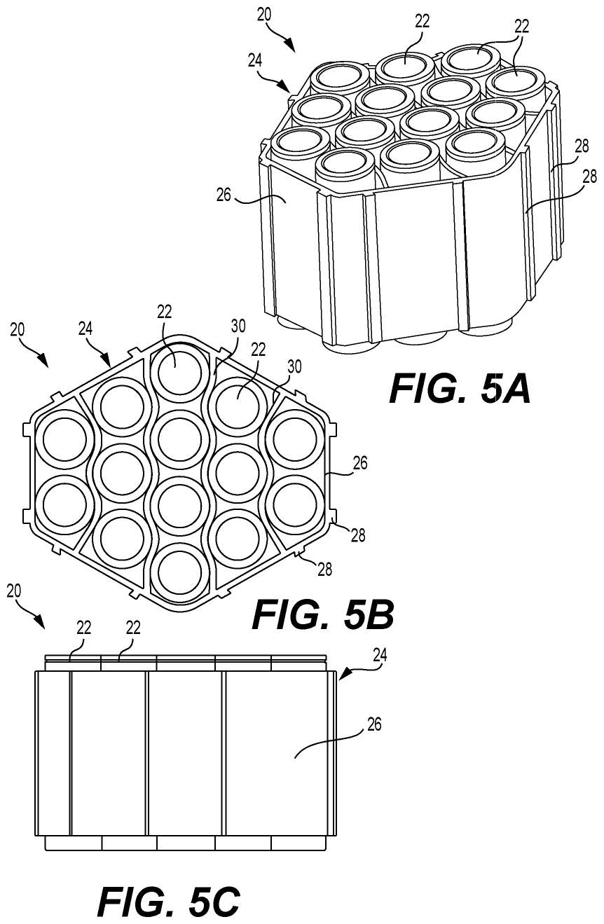

FIGS. 5A-5C show details of a battery module 20 of the present disclosure. The battery module 20 includes a plurality of battery cells 22. For simplicity of disclosure only a few of the battery cells 22 are labeled. Each of the battery cells 22 has a cylindrical shape defining a cell axis, with the cell axes of the battery cells being mutually parallel. However, battery cells 22 having other configurations may be used, such as pouch cells, prismatic cells, etc.

Each battery module 20 includes an enclosure 24 surrounding the plurality of cells 22 of the battery module 20. The enclosure 24 is configured to function as a structural component of the battery pack 10. For example, each of the enclosures 24 may transmit load forces between the baseplate 12 and the top cover 12. In some embodiments, the battery cells 22, themselves may provide a structural function, such as transmitting load forces between the baseplate 12 and the top cover 12. The enclosure 24 may provide additional structural support to hold the battery cells 22 in a particular orientation, thereby enabling the battery cells 22 to provide the desired structural function. Alternatively or additionally, the battery cells 22 and/or the enclosures 24 may function as a structural component of a vehicle incorporating the battery pack 10. The battery cells 22 and/or the enclosures 24 may transmit static and/or dynamic loads to various components of the vehicle. Thus, the battery cells 22 and/or the enclosures 24 may form an integral part of the structure of the vehicle.

In some embodiments, and as shown in FIGS. 5A-5C, the enclosure 24 includes a peripheral wall 26 surrounding the plurality of cells 22. The peripheral wall 26 has a generally tubular shape. In some embodiments, the enclosure 24 also includes a plurality of stiffening ribs 28 disposed on an outside surface of the peripheral wall 26 and extending parallel to an axis of the tubular shape of the peripheral wall 26. The stiffening ribs 28 may provide structural rigidity to the enclosure 24. Alternatively or additionally, the stiffening ribs 28 may provide other functions, such as transmitting heat away from the peripheral wall 26 and/or providing a spacing between two or more of the battery modules 20 within the battery pack 10, which may allow for a cooling fluid, such as a liquid or a gas, to be circulated therethrough.

In some embodiments, and as shown in FIGS. 5A-5C, each of the battery cells 22 within a battery module 20 have a generally cylindrical shape defining a cell axis, with the cell axes of each of the battery cells 22 being mutually parallel. In some embodiments, the tubular shape of the peripheral wall 26 defines a wall axis that is parallel to the cell axes of the battery cells 22 within the battery module 20. In some embodiments, and as shown in FIGS. 5A-5C, the tubular shape of the peripheral wall 26 defines a wall height in an axial direction and which is shorter than an axial length of the battery cells 22 within the battery module 20.

In some embodiments, and as shown in FIGS. 5A-5C, the enclosure 24 includes at least one internal wall 30 disposed between two or more of the battery cells 22 within the battery module 20. In some embodiments, and as shown in FIGS. 5A-5C. In some embodiments, and as shown in FIGS. 5A-5C, the enclosure 24 includes a plurality of the internal walls 30 each extending generally parallel to one another. In some embodiments, the internal wall 30 includes a first end and a second end opposite the first end, with each of the first end and the second end connected to an interior surface of the peripheral wall 26. In some embodiments, the internal walls 30 each define a sinusoidal shape that weaves through the predetermined pattern of the battery cells 22 within the battery module 20. The internal walls 30 may provide structural rigidity to the enclosure 24. Alternatively or additionally, the internal walls 30 may provide other functions, such as transmitting heat away from the battery cells 22.

The electric layout of an energy storage system (ESS) typically is divided in serial and parallel connected battery cells 22. From electrical perspective a sum of battery cells 22 represents a reasonable minimum package of battery cells 22 (i.e. a battery module 20). Within this battery module 20, the battery cells 22 could follow a serial or parallel interconnection. The battery module 20 could also be a subset of the main ESS topology of the battery pack 10.

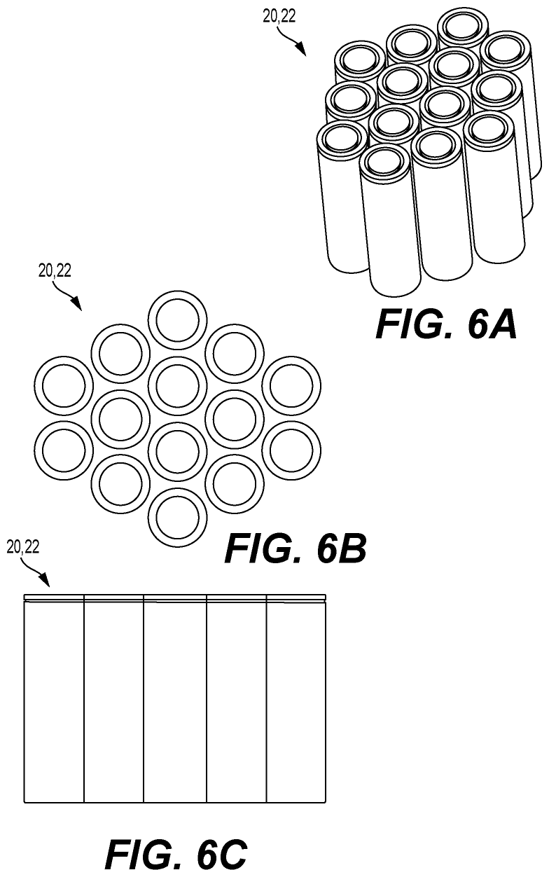

FIGS. 6A-6C show an arrangement of battery cells 22 in the battery module 20 of FIG. 5A. The battery module 20 may have a shape may follow rectangular, honeycomb or similar reasonable styles.

This arrangement is merely one example. The arrangement of battery cells 22 in battery module 20 be determined based on a number of battery cells 22 in the battery module 20. This may be determined, for example, based on design requirements for the battery pack 10. For example, an ESS design may require by fourteen (14) serial and eighty-four (84) parallel connected battery cells 22, in total eleven hundred, seventy-six (1176) of the battery cells 22. These requirements may be determined based on a combination of power, voltage, and/or current delivery requirements for the battery pack 10 and power, voltage, and/or current delivery capabilities of the battery cells 22.

The number of battery cells 22 in each battery module 20 may be determined based on a greatest common divisor of the serial and parallel connected cells. For example, a greatest common divisor from 14 & 84 is fourteen (14), which is the number of the battery cells 22 in each of the battery modules 20. Arranging fourteen (14) battery cells 22 each having a cylindrical shape leads to a honeycomb shape, using 2+3+4+3+2=fourteen (14) cells. Electrically, these battery cells 22 are connected in parallel, at this example. The battery module 20 includes these fourteen (14) battery cells 22 in a honeycomb configuration. A different number of battery cells 22 may lead to a different basic shape, e.g., sixteen (16) battery cells 22 could be arranged in quadrilateral shape. Twelve (12) or fifteen (15) battery cells 22 could be arranged in rectangular shape. Any of ten (10), thirteen (13), or fourteen (14) battery cells 22 having a cylindrical shape could be arranged in honeycomb shape.

The present disclosure provides for an ESS for a vehicle that combines functionalities for energy storage and chassis load distribution by merging package intensive and relatively heavy parts. A first step in the design of the present disclosure is to provide a regular and shared geometric shape for the battery cells 22 within each battery module 20 in the battery pack 10. A second step in the design of the present disclosure is to enclose the battery cells 22 by the enclosure 24 of structural material. A third step in the design of the present disclosure is to pattern the battery modules 20. For example, the battery modules 20 are arranged in an interlocking pattern as shown in the battery pack 10 shown in FIGS. 1 and 2A-2B. Electrically connecting the battery modules 20, leads to a main ESS topology, where the battery modules 20 can switch location from global perspective. In other words, the battery modules 20 may each be swappable with any other one of the battery modules 20 within a given battery pack 10 and/or to form other configurations for the battery pack 10.

This this design may provide flexibility for constructing and servicing of the battery pack 10. This design may also provide flexibility to use a common construction for the battery modules 20 in two or more different battery packs 10, which may have a different size, shape, and/or electrical output requirements, such as voltage or energy storage capacity.

The present disclosure provides a design for a battery module 20 that combines electrical and structural functions, wherein the enclosure 24 of the battery cells 22 provides a structural function. In some embodiments, the battery cells 22, themselves may provide a structural function, such as transmitting load forces between the baseplate 12 and the top cover 12.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A battery pack for a vehicle and comprising:
a plurality of battery modules arranged in a first predetermined pattern;
each battery module of the plurality of battery modules including a plurality of battery cells arranged in a second predetermined pattern; and
each battery module of the plurality of battery modules including an enclosure surrounding the plurality of cells and configured to function as a structural component of at least one of the battery pack or the vehicle.

2. The battery pack of claim 1, further comprising a baseplate having a generally flat shape defining the first predetermined pattern and configured to hold the plurality of battery modules thereupon.

3. The battery pack of claim 2, wherein the first predetermined pattern includes a single layer of the plurality of battery modules disposed on the baseplate.

4. The battery pack of claim 1, wherein the first predetermined pattern includes the plurality of battery modules arranged in two or more layers.

5. The battery pack of claim 1, further comprising a top cover having a generally flat shape defining the first predetermined pattern and configured overly the plurality of battery modules.

6. A battery module for a battery pack in a vehicle, the battery module comprising:
a plurality of battery cells arranged in a predetermined pattern; and
an enclosure surrounding the plurality of cells and configured to provide a structural component of the battery pack or the vehicle,
wherein the enclosure further comprises a plurality of internal walls each disposed between two or more battery cells of the plurality of battery cells and extending generally parallel to one another.

7. The battery module of claim 6, wherein the predetermined pattern defines a honeycomb shape.

8. The battery module of claim 6, wherein the predetermined pattern defines a rectangular shape.

9. The battery module of claim 6, wherein the enclosure comprises a peripheral wall surrounding the plurality of cells and having a generally tubular shape.

10. The battery module of claim 9, wherein the enclosure further comprises a plurality of stiffening ribs disposed on an outside surface of the peripheral wall.

11. The battery module of claim 9, wherein the plurality of battery cells each have a generally cylindrical shape defining a cell axis with the cell axis of each battery cell of the plurality of battery cells being mutually parallel.

12. The battery module of claim 11, wherein the tubular shape of the peripheral wall defines a wall axis that is parallel to the cell axes of the plurality of battery cells.

13. The battery module of claim 11, wherein the tubular shape of the peripheral wall defines a wall height in an axial direction and which is shorter than an axial length of the generally cylindrical shape of each of the plurality of battery cells.

14. The battery module of claim 9,
wherein each internal wall of the plurality of internal walls includes a first end and a second end opposite the first end, with each of the first end and the second end connected to an interior surface of the peripheral wall.

15. The battery module of claim 14, wherein the plurality of battery cells each have a generally cylindrical shape; and
wherein each internal wall of the plurality of internal walls defines a sinusoidal shape through the predetermined pattern of the plurality of battery cells.

16. The battery module of claim 6, wherein the enclosure comprises a peripheral wall surrounding the plurality of cells, and wherein each internal wall of the plurality of internal walls includes a first end and a second end opposite the first end, with each of the first end and the second end connected to an interior surface of the peripheral wall.

17. The battery module of claim 1, wherein the enclosure further comprises a plurality of internal walls each defining a generally sinusoidal shape through the predetermined pattern of the plurality of battery cells.

18. The battery module of claim 17, wherein plurality of internal walls each extend generally parallel to one another.

19. A battery module for a battery pack in a vehicle, the battery module comprising:
a plurality of battery cells arranged in a predetermined pattern; and
an enclosure surrounding the plurality of cells and configured to provide a structural component of the battery pack or the vehicle;
wherein the enclosure further comprises a plurality of internal walls each disposed between two or more battery cells of the plurality of battery cells and extending generally parallel to one another,
wherein each internal wall of the plurality of internal walls defines a sinusoidal shape through the predetermined pattern of the plurality of battery cells.

20. The battery module of claim 19, wherein the enclosure comprises a peripheral wall surrounding the plurality of cells, and
wherein each internal wall of the plurality of internal walls includes a first end and a second end opposite the first end, with each of the first end and the second end connected to an interior surface of the peripheral wall.
